(19) United States
(12) Patent Application Publication
(10) Pub. No.: US 2013/0136425 A1
(43) Pub. Date: May 30, 2013

(54) GROUP BASED RECORDING SCHEDULE

(71) Applicants: Tim Herby, Los Altos, CA (US); Antonio Fontan, San Jose, CA (US); Christopher Habliston, San Jose, CA (US); Alan Merzon, San Jose, CA (US)

(72) Inventors: Tim Herby, Los Altos, CA (US); Antonio Fontan, San Jose, CA (US); Christopher Habliston, San Jose, CA (US); Alan Merzon, San Jose, CA (US)

(73) Assignee: MICROSOFT CORPORATION, Redmond, WA (US)

(21) Appl. No.: 13/305,602

(22) Filed: Nov. 28, 2011

(51) Int. Cl. H04N 5/76

(52) U.S. Cl. 386/296; 386/E05.003

(57) ABSTRACT

According to one aspect of the present disclosure, it is recognized that a threshold number of members in a trend group intend to view a content item. The content item is automatically added, for each member in the trend group, to a recording schedule of that member of the trend group. The recording schedule of each member of the trend group is maintained at a recording schedule service and indicates content items to be recorded by a content recording device.

### BACKGROUND

Watching television and movie programs can be a social experience. People often spend significant time and energy sharing thoughts and opinions related to television and movie programs. Typically, if a person hears of a potentially interesting program, that person can find that program on her own to view later. However, it can be difficult to remember the programs one hears about, and finding such programs may be laborious and time consuming.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure

According to one aspect of the present disclosure, it is recognized that a threshold number of members in a trend group intend to view a content item. The content item is automatically added, for each member in the trend group without an overriding setting, to a recording schedule of that member of the trend group. The recording schedule of each member of the trend group is maintained at a recording schedule service and indicates content items to be recorded by a content recording device.

### BRIEF DESCRIPTION OF THE DRAWINGS

FIG. 1 schematically shows a system for managing recording schedules.

FIG. 2 shows an example method for managing recording schedules.

FIG. 3 shows another example method for managing recording schedules.

FIG. 4 shows example recording schedules of an example trend group.

FIG. 5 shows the example recording schedules of FIG. 4, modified according to the method of FIG. 2.

FIG. 6 shows example recording schedules of an example personal trend group.

FIG. 7 shows the example recording schedules of FIG. 6, modified according to the method of FIG. 3.

FIG. 8 schematically shows a computing system for performing the methods of FIG. 2 and FIG. 3.

### DETAILED DESCRIPTION

The present description is related to automatically recording content items such as television broadcasts, movies, or webcasts, for example. In particular, the present description is related to automatically recording content items that are currently popular among a certain group of people. As a nonlimiting example, a person may be able to join a trend group, such that anytime a content item becomes popular among members of the trend group, that content item is automatically recorded for all members of the trend group.

As another nonlimiting example, a person may follow a personal trend group, such that when a content item becomes popular among members of the personal trend group, that content item is automatically recorded for just the user following the personal trend group.

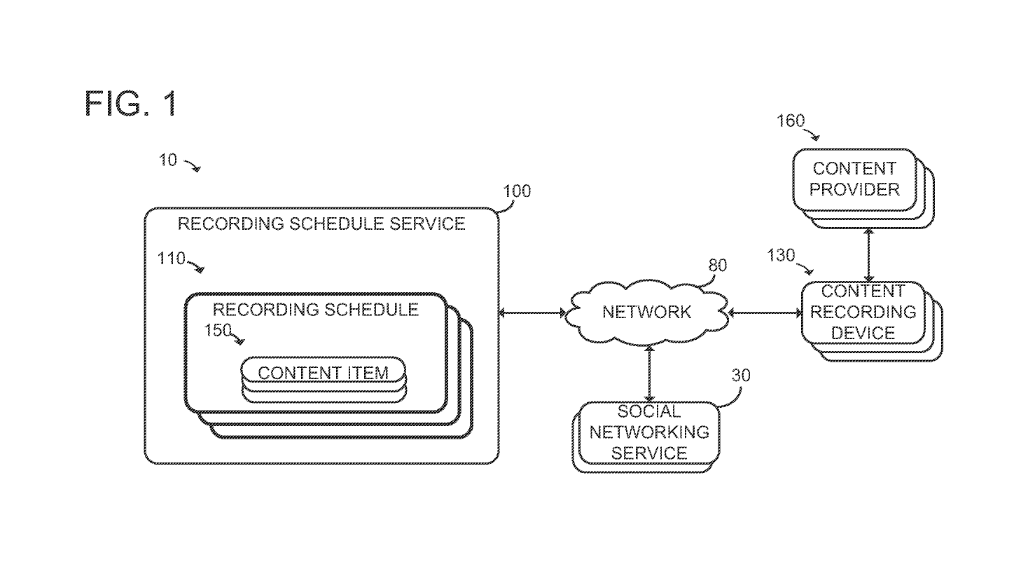

FIG. 1 schematically shows a system 10 for creating and using recording schedules 110. System 10 includes content recording devices 130, recording schedule service 100, social networking services 30, and content providers 160, which may share information via a network 80, such as the Internet.

Content recording devices 130 are configured to receive and record content items 150 from content providers 160. A content item 150 may include virtually any audio-visual content, such as a television show, a webcast, a radio show, or a movie, for example. The content items 150 may be delivered to content recording devices 130 via any suitable transmission mechanism, including but not limited to over-the-air broadcasts, cable broadcasts, satellite broadcasts, and/or Internet broadcasts. Content providers 160 may provide such content items for free, as part of a subscription package, on an ‘on demand’ basis, or via virtually any other distribution model. It should be appreciated that the content items may be received from more than one content provider. In some embodiments, content recording devices 130 may be configured to receive and record content pointers. Pointers may indicate a location where an item of audio-visual content is located. The pointers may be accessed at time of playback to retrieve the content on an “on-demand” basis.

Recording schedules 110 may be used to indicate to content recording devices 130 which content items 150 are to be recorded. Recording schedules 110 may be associated with a particular content recording device 130 and/or a particular user profile. Thus, it is possible to add a content item 150 to a recording schedule 110 so that a particular content recording device 130 will record that content item, or so that more than one content recording device 130 associated with the same user profile will record that content item. It is to be appreciated that recording schedules 110 may contain an indication of content items 150 to be recorded rather than actual content items. Thus, a content item is “added” to a recording schedule by adding an indicator of that content item.

Recording schedule service 100 may be cooperatively configured to communicate with content recording devices 130 via a network, as shown in FIG. 1. In such embodiments, the recording schedule service may execute on one or more remotely located computing devices. However, in some embodiments, each of the content recording devices 130 may locally execute a recording scheduling service for that content recording device. In such embodiments, a data warehouse service may be located on one or more remotely located computing devices cooperatively configured to communicate with content recording devices 130 via a network. The data warehouse service may house all the recording schedules 110 of all users, and may be configured to perform the trend analysis described below.

Recording schedule service 100 may maintain, create, and/or modify recording schedules 110. When executing remotely, recording schedule service 100 may have read and/or write access to recording schedules for a plurality of devices and/or users. Recording information from a first user may be used to create, modify and/or maintain a recording schedule of a second user.

Social networking services 30 may include one or more services that are capable of recognizing a virtual identity of a user (e.g., a user profile) and the social connections of that user (e.g., friend profiles). Social networking services 30 may be utilized by recording schedule service 100. For example, the recording schedule may receive and/or share user information with one or more social networking services via an application programming interface (API) or other suitable mechanism. Social networking services 30 may share virtually any user information, such as recording/viewing habits of a user or a user's social graph, for example. In some embodiments, social networking services 30 may be configured to show which content items a user wishes to share with others. In some embodiments, recording schedule service 100 may be integrated with one or more social networking services.

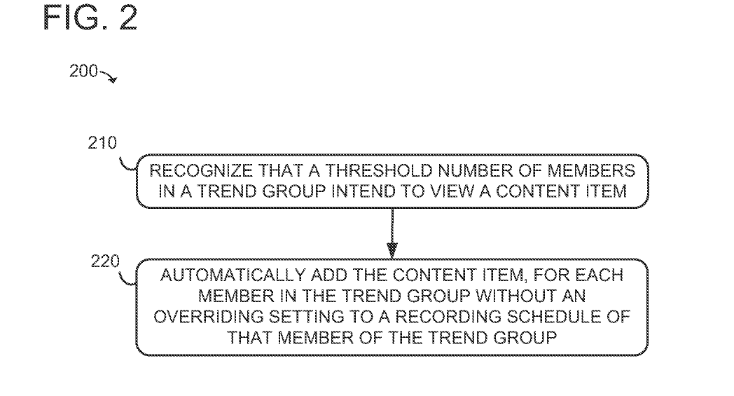

Turning to FIG. 2, FIG. 2 shows a method 200 for automatically adding content items 150 to recording schedules 110. The method 200 may be performed at recording schedule service 100 or content recording device 130, for example.

At 210, method 200 includes recognizing that a threshold number of members in a trend group intend to view a content item. A trend group may comprise a group of users, where each user has their own associated recording schedule.

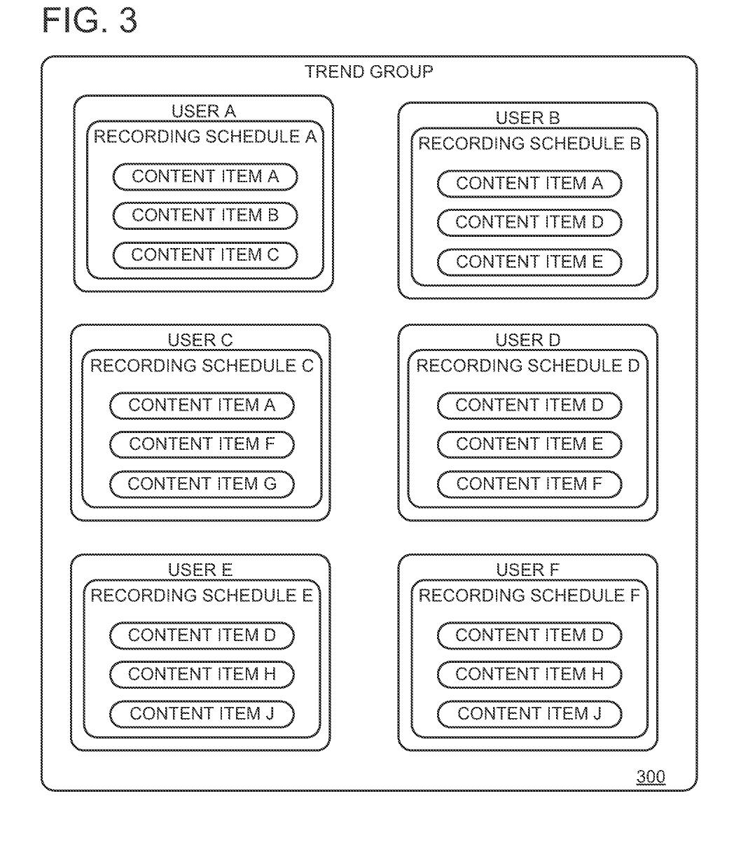

Turning briefly to FIG. 3, FIG. 3 schematically shows one embodiment of a trend group 300. The trend group 300 of FIG. 3 has six members, each with their own associated recording schedule. It should be appreciated that a trend group may have a virtually unlimited number of members. Operations on the recording schedules of the members of the trend group may be performed by recording schedule service 100 based on actions of members in that group.

Trend groups may be formed via any suitable method. In one embodiment, a user may indicate, via a user interface, that they wish to form a trend group. The user interface may be provided in virtually any manner, such as via a web page. Other users may join the trend group through similar user interfaces.

Information corresponding to each member in the trend group may be received to determine which content items each member in the trend group intends to view and/or record. Such information may be gleaned from that member's recording schedule.

Other methods of determining if a member intends to view a content item may be employed. In some embodiments, a user may indicate that he intends to view a content item without adding it to his recording schedule, such as by posting on a social networking service. As another example, if a device associated with the user is actively presenting a content item, it is clear that the user intends to view that content item. Also, if a user has consistently viewed/recorded related content items, it can be inferred that the user intends to view and/or record upcoming related items. For example, if a user has viewed every episode of a television series, it may be determined that the user also intends to view the next episode of the television series.

The trend group may be a private trend group requiring an administrator to add or remove members. The administrator may be any user, such as the user that started the trend group. The administrator may have other privileges and/or responsibilities related to the trend group. For example, the administrator may specify that no content items with a particular rating are added to recording schedules of members of that trend group as a condition of participation in that trend group. The administrator may specify an age limit for the members of the trend group, or a limit to the number of members that are allowed to join the trend group, for example.

The trend group may be a public trend group allowing members to join or leave the trend group without receiving approval from an administrator. As such, any user may be free to leave or join the public trend group. It should be appreciated that a public trend group may have an administrator with privileges and/or responsibilities related to the trend group.

Returning to 210 of FIG. 2, the threshold number of members may be any suitable number. In some embodiments, the threshold number of members is a fixed percentage of the total number of members in the group (e.g., fifty percent). In some embodiments, the threshold number of members is a first percentage of a total number of members of the trend group if the total number of members of the trend group is less than a reference number, and is a second percentage of the total number of members of the trend group if the total number of members of the trend group is greater than the reference number (e.g., fifty percent if less than one hundred trend group members and forty percent if at least one hundred trend group members).

In other words, the threshold number of members may increase or decrease according to the size of the trend group. In some embodiments, the threshold number of members decreases with increasing trend group size. For example, the first percentage may be greater than the second percentage. In other embodiments, the threshold number of members increases with increasing trend group size.

The method 200 may include, at 220, automatically adding the content item, for each member in the trend group without an overriding setting, to a recording schedule of that member of the trend group. Overriding settings may bar automatic addition of a content item. In one example, an overriding setting may be applied such that no content items of a particular rating (e.g., R, TV-MA, etc.) are added to a recording schedule. As another example, a particular content item may not be added to the recording schedule of a particular user if that user does not have means to record the content item (e.g., recording device lacks sufficient space for downloading and/or recording device lacks access to content item). However, if a group member does not have an overriding setting to override automatic addition of the content item, the content item may be added to a corresponding recording schedule of the user.

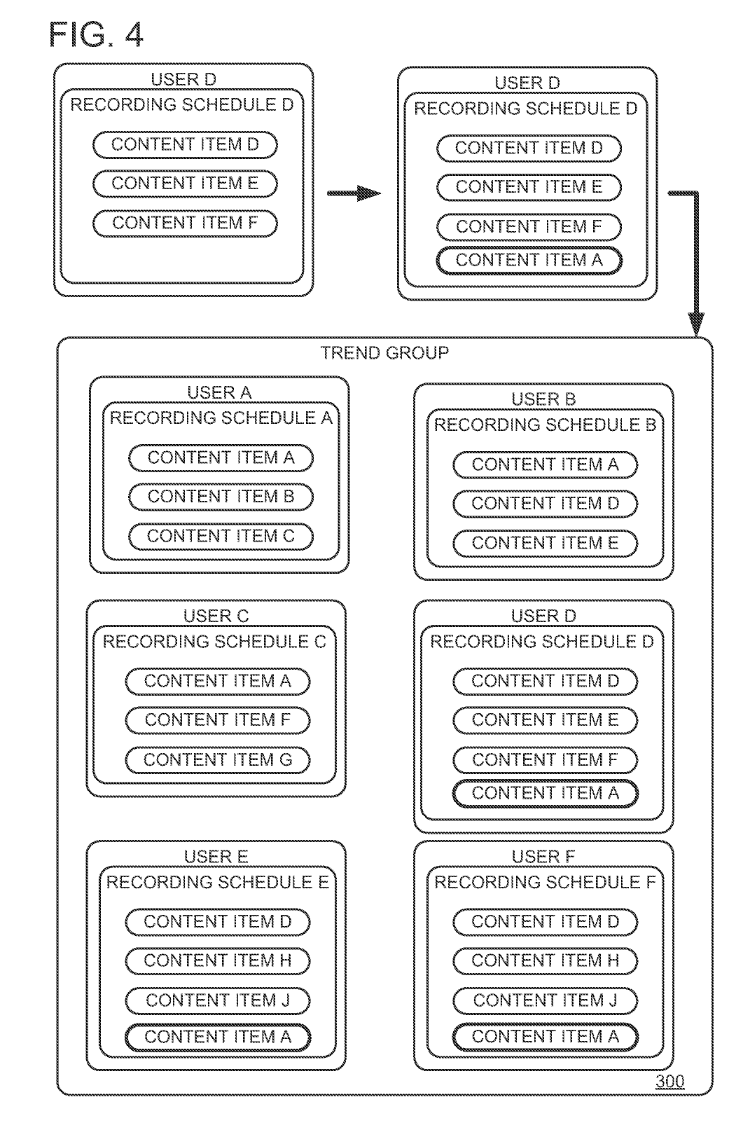

Turning briefly to FIG. 4, FIG. 4 schematically shows user D of trend group 300 from FIG. 3 adding content item A to recording schedule D. After user D adds content item A, four of the six users are set to record content item A. In this example, the threshold number of members necessary for a content item to be automatically added to other member's recording schedule is greater than fifty percent (i.e., four members). As such, user D adding content item A causes the threshold number of members to be met for content item A. In response, content item A is automatically added to recording schedules for all other members of the trend group 300 without an overriding setting (i.e., user E and user F).

An overriding setting may be specific to each user in the trend group. For example, a user may be a member of a sports trend group, in hopes of having popular sports related content items added to their recording schedule. The user may also specify a setting such that bicycling related content items, for example, are blacklisted and thus are not added to their recording schedule, even if they are sports related. Thus, even if a threshold number of members intend to view the blacklisted content item, that item may not be added to the recording schedule of the user with that content item blacklisted. Blacklisting can be applied to virtually any content item based on virtually any criteria, such as rating, content, or length, for example.

Other settings may be applied as well. For example, settings may be applied to limit the amount of automatically recorded content items, to record only high-definition content items, or to record only content items of a particular language. It should be appreciated that virtually any setting may be utilized without departing from the scope of this disclosure.

Some trend groups may have members to which other members are willing to provide more deference. Such members may be referred to as trend-setters. It may be advantageous to give more weight to the viewing habits of certain users, such as trend-setters, when deciding which content items to automatically record. Thus, in some embodiments, one or more member's contribution towards reaching the threshold is weighted differently than one or more other member's contribution towards reaching the threshold.

For example, if a given number of trend-setters intend to view a content item, that content item may be automatically added to recording schedules of members of the trend group. If that same given number of non trend-setters intends to view the content item, it may not be automatically added to the recording schedules. The weighting of a trend-setter compared to a non trend-setter may be set at any desired amount. As a nonlimiting example, a trend-setter may count as 1.5, 2, 5, 10, or some other number of non trend-setters. In some examples, the weighting may scale up or down with the total number of members, the total number of trend-setters in the group, or another suitable factor.

It should be appreciated that content items may be recorded as soon as they are added to a recording schedule. Thus, if a content item is added to a recording schedule, and that content item is currently being broadcast, recording may start immediately. For example, if over a threshold number of members of a trend group start watching a particular content item, that content item may be added to the recording schedules of other users. Furthermore, recording may begin immediately for such other users, even if the initial portion of the content item is not able to be recorded. In some embodiments, if a new content item that is added to the recording schedule is a currently airing content item, e.g., a television program that is airing at the time the content item is added, the currently airing content item may not be immediately added, but a complete re-broadcast of the content item may be added. In another embodiment, if the new content item is currently airing, the remainder of the content item (e.g., the portion of the content item that has yet to air) can be immediately added but replaced with a complete re-broadcast of the content item when the re-broadcast becomes available at a later time.

In some embodiments, content items are only added if the trend group has greater than a minimum amount of members. This may be beneficial to ensure anonymity among users, so that one user may not easily infer what another user has on his recording schedule, or to avoid mirroring entire recording schedules.

It should be appreciated that a user may be a member of more than one trend group. Thus, if a content item is automatically added to a recording schedule of a user due to that user being a member of a first group, that same user may trigger a second trend group to record that content item if the threshold number is then met in the second group. Such a waterfall effect may be advantageous in that a small trend may be amplified to reach a large number of users.

However, it may also be advantageous to disable the waterfall effect. Thus, in some embodiments, users with content items that have been automatically added are not considered when deciding if a threshold has been met. As such, a content item automatically added in one trend group may not affect recording schedules of other groups.

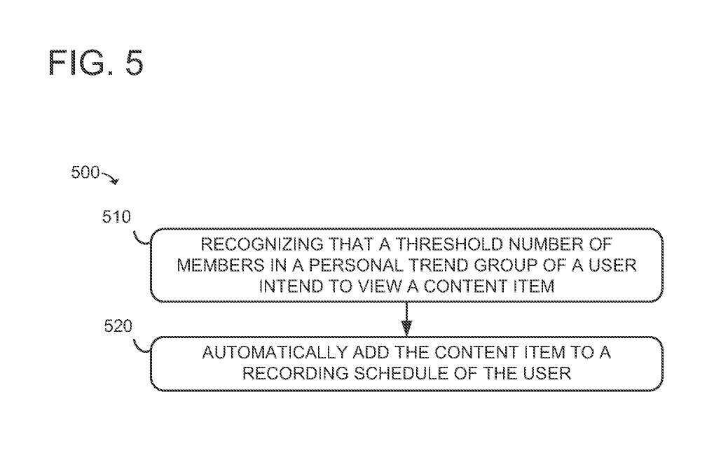

Turning to FIG. 5, FIG. 5 shows another method 500 for managing recording schedules. The method 500 may be performed on recording schedule service 100, for example. At 510, method 500 includes recognizing that a threshold number of members in a personal trend group of a user intend to view a content item. A personal trend group may be user-specific, for example it may include a group of that user's friends, e.g., a personal trend group. In other words, a personal trend group may exist for the purposes of determining content items to be added to only that user's recording schedule. In some embodiments, a personal trend group may include only those friends that a user has approved/confirmed.

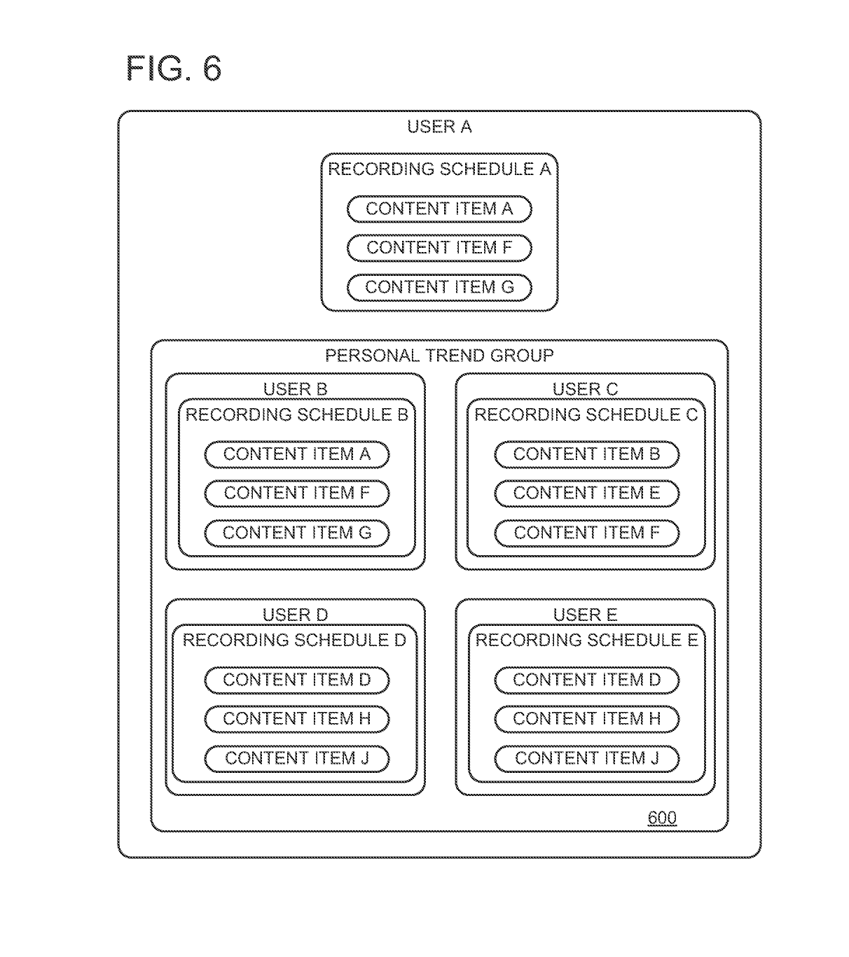

Turning briefly to FIG. 6, FIG. 6 schematically shows an example personal trend group 600. The example personal trend group 600 is specific to user A. Changes to recording schedules of members of user A's personal trend group 600 may affect user A, but may not affect other members of the personal trend group 600 (i.e., users B, C, D, and E).

A user may set up a personal trend group via any suitable method. For example, a user may have an existing social graph formed from online activities, such as activities associated with a social networking service. The personal trend group may include one or more members selected by the user for inclusion in a social graph of the user. As such, the personal trend group may comprise acquaintances of the user. Also, the personal trend group for recording purposes may include only a subset of members in the social graph of the user. For example, a user may hand pick, from their social graph, members to be included in their recording personal trend group.

Turning back to FIG. 5, the method 500 may include, at 520, automatically adding the content item to a recording schedule of the user. In this way, only the recording schedule of a particular user is affected.

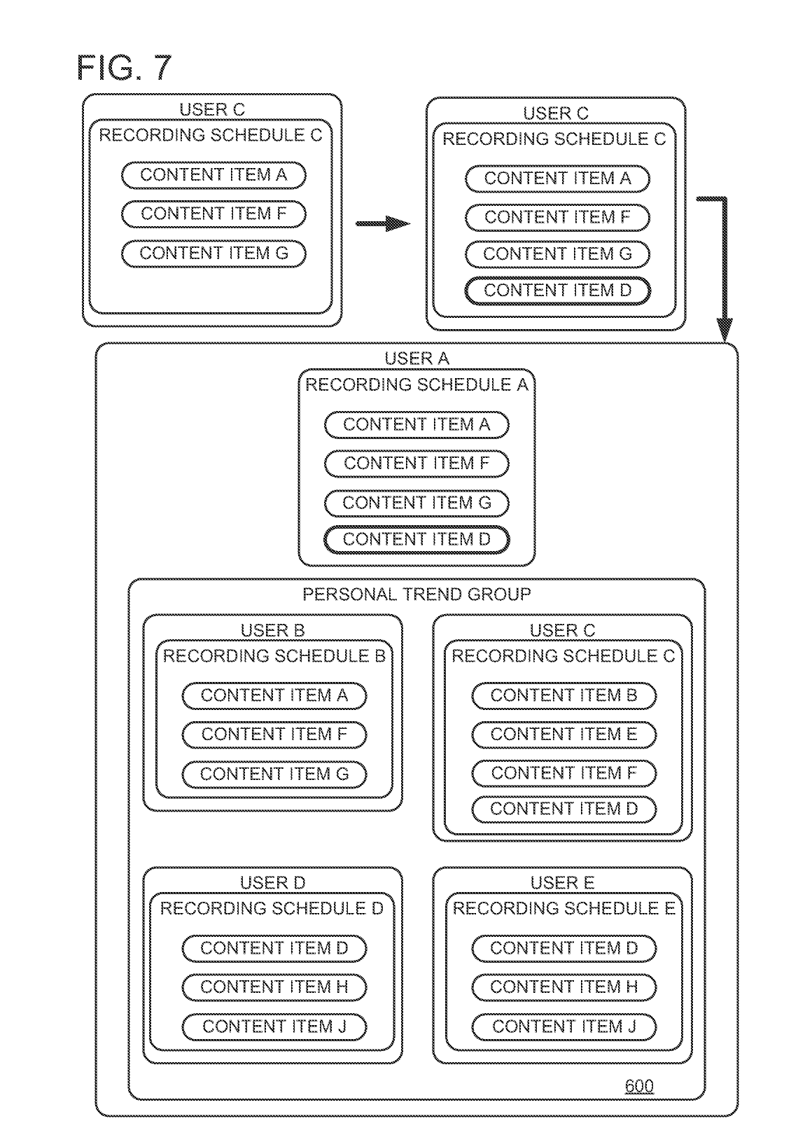

Turning to FIG. 7, FIG. 7 schematically shows user C of personal trend group 600 from FIG. 6 adding content item D to recording schedule C. In this example, the threshold number of members necessary for a content item to be automatically added to the recording schedule A is greater than fifty percent (i.e., 3 members). As such, user C adding content item D causes the threshold number of members to be met for content item D. In response, content item D is automatically added to recording schedule A of user A, and all other recording schedules of the personal trend group are left unaffected.

The threshold number of members may be determined for personal trend groups in a similar way as determined for trend groups. For example the threshold number of members may be a percentage of the total number of members. That percentage may be dependent on the total number of members, and may increase or decrease as the total number of members grows. Trend-setting users may be assigned different weights, as described above with respect to trend groups.

The aforementioned waterfall effect may occur via a personal trend group as well. For example, a user with a personal trend group may also belong to a trend group. If the user has a content item automatically added via their personal trend group, the threshold number may be reached in the trend groups of which the user is a member.

Settings may be applied in the context of a personal trend group in much the same way as described in relation to a trend group. For example, a user can blacklist certain content items, or specify a limit to the amount of content items that are automatically added.

For both personal trend groups (e.g., friend groups) and trend groups, a user interface may be provided to receive user commands and display information related to managing recording schedules. Example user commands include creating friend/trend groups, joining and leaving groups, requesting to view content recording schedules, modifying recording schedules, etc. Displayed information may include the number of members of a group, a listing of groups that to which a user is a member, recording schedules, popular content items, or a list of other groups to join, for example.

In some embodiments, the above described methods and processes may be tied to a computing system including one or more computers. In particular, the methods and processes described herein may be implemented as a computer application, computer service, computer API, computer library, and/or other computer program product.

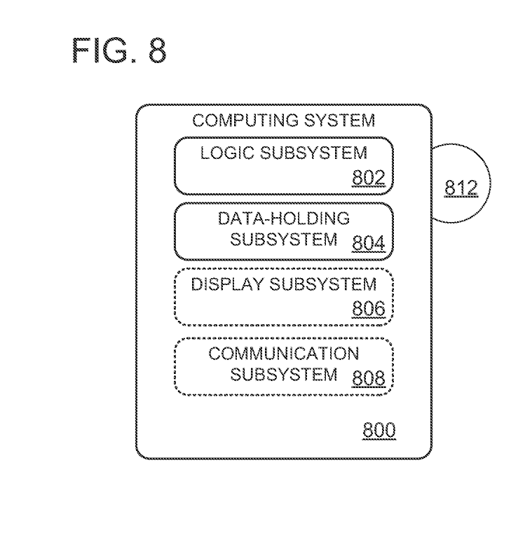

FIG. 8 schematically shows a nonlimiting computing system 800 that may perform one or more of the above described methods and processes. In some embodiments, a recording device 130, social networking services 30, and/or recording schedule service 100 may take the form of one or more computing system 800. Computing system 800 is shown in simplified form. It is to be understood that virtually any computer architecture may be used without departing from the scope of this disclosure. In different embodiments, computing system 800 may take the form of a mainframe computer, server computer, desktop computer, laptop computer, tablet computer, home entertainment computer, network computing device, mobile computing device, mobile communication device, gaming device, etc. Content recording device 130, social networking services 30, and/or recording schedule service 100 may optionally take the form of one or more of the below described computing system 800.

Computing system 800 includes a logic subsystem 802 and a data-holding subsystem 804. Computing system 800 may optionally include a display subsystem 806, communication subsystem 808, and/or other components not shown in FIG. 8. Computing system 800 may also optionally include user input devices such as remote controls, keyboards, mice, game controllers, cameras, microphones, and/or touch screens, for example.

Logic subsystem 802 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 804 may include one or more physical, non-transitory, devices configured to hold data and/or instructions executable by the logic subsystem to implement the herein described methods and processes. When such methods and processes are implemented, the state of data-holding subsystem 804 may be transformed (e.g., to hold different data).

Data-holding subsystem 804 may include removable media and/or built-in devices. Data-holding subsystem 804 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 804 may include devices with one or more of the following characteristics: volatile, nonvolatile, dynamic, static, read/write, read-only, random access, sequential access, location addressable, file addressable, and content addressable. In some embodiments, logic subsystem 802 and data-holding subsystem 804 may be integrated into one or more common devices, such as an application specific integrated circuit or a system on a chip.

FIG. 8 also shows an aspect of the data-holding subsystem in the form of removable computer-readable storage media 812, which may be used to store and/or transfer data and/or instructions executable to implement the herein described methods and processes. Removable computer-readable storage media 812 may take the form of CDs, DVDs, HD-DVDs, Blu-Ray Discs, EEPROMs, and/or floppy disks, among others.

It is to be appreciated that data-holding subsystem 804 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

It is to be appreciated that a “service”, as used herein, may be an application program executable across multiple user sessions and available to one or more system components, programs, and/or other services. In some implementations, a service may run on a server responsive to a request from a client.

When included, display subsystem 806 may be used to present a visual representation of data held by data-holding subsystem 804. As the herein described methods and processes change the data held by the data-holding subsystem, and thus transform the state of the data-holding subsystem, the state of display subsystem 806 may likewise be transformed to visually represent changes in the underlying data. Display subsystem 806 may include one or more display devices utilizing virtually any type of technology. Such display devices may be combined with logic subsystem 802 and/or data-holding subsystem 804 in a shared enclosure, or such display devices may be peripheral display devices.

When included, communication subsystem 808 may be configured to communicatively couple computing system 800 with one or more other computing devices. Communication subsystem 808 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 800 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for managing a recording schedule, the method comprising:
recognizing that a threshold number of members in a trend group intend to view a content item; and
automatically adding the content item, for each member in the trend group without an overriding setting, to a recording schedule of that member of the trend group, the recording schedule maintained at a recording schedule service and indicating content items to be recorded by a content recording device.

2. The method of claim 1, where the trend group is a private trend group requiring an administrator to add or remove members.

3. The method of claim 1, where the trend group is a public trend group allowing members to join or leave the trend group without receiving approval from an administrator.

4. The method of claim 1, where the threshold number of members is a first percentage of a total number of members of the trend group if the total number of members of the trend group is less than a reference number, and where the threshold number of members is a second percentage of the total number of members of the trend group if the total number of members of the trend group is greater than the reference number.

5. The method of claim 4, where the first percentage is greater than the second percentage.

6. The method of claim 1, where one or more member's contribution towards reaching the threshold is weighted differently than one or more other member's contribution towards reaching the threshold.

7. The method of claim 1, where the content items are recorded via more than one content provider.

8. The method of claim 1, where the recording schedule service executes as part of the content recording device.

9. The method of claim 1, where the recording schedule service and the content recording device are cooperatively configured to communicate via a network.

10. A data-holding subsystem holding instructions executable by a logic subsystem to:
recognize that a threshold number of members in a trend group intend to view a content item; and
automatically adding the content item, for each member in the trend group without an overriding setting, to a recording schedule of that member of the trend group, the recording schedule of each member of the trend group being maintained at a recording schedule service and indicating content items to be recorded by a content recording device.

11. The data-holding subsystem of claim 10, where the trend group is one of a private trend group requiring an administrator to add or remove members or a public trend group allowing members to join or leave the trend group without receiving approval from an administrator.

12. The data-holding subsystem of claim 10, where the threshold number of members is a first percentage of a total number of members of the trend group if the total number of members of the trend group is less than a reference number, and where the threshold number of members is a second percentage of the total number of members of the trend group if the total number of members of the trend group is greater than the reference number.

13. The data-holding subsystem of claim 10, where one or more member's contribution towards reaching the threshold is weighted differently than one or more other member's contribution towards reaching the threshold.

14. A method for managing a recording schedule, the method comprising:
recognizing that a threshold number of members in a personal trend group of a user intend to view a content item; and
automatically adding the content item to a recording schedule of the user, the recording schedule being maintained on an electronic recording schedule device and indicating content items to be recorded by a content item content recording device.

15. The method of claim 14, where the personal trend group includes one or more members selected by the user for inclusion in a social graph of the user.

16. The method of claim 15, where the personal trend group includes a subset of members selected by the user for inclusion in the social graph of the user.

17. The method of claim 14, where the threshold number of members is a first percentage of a total number of members of the group if the total number of members of the group is less than a reference number, and is a second percentage if the total number of members of the group is greater than the reference number.

18. The method of claim 14, where one or more member's contribution towards reaching the threshold is weighted differently than one or more other member's contribution towards reaching the threshold.

19. The method of claim 14, where the content item is recorded via more than one content provider.

20. The method of claim 14, where the content item is a television broadcast.
